(19) United States
(12) Patent Application Publication
(10) Pub. No.: US 2003/0210345 A1
(43) Pub. Date: Nov. 13, 2003

(54) Image pickup device and method for capturing subject with wide range of brightness

(76) Inventors: Satoru Nakamura, Yamato-shi (JP); Kenichi Shinotsuka, Ome-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/419,129

(22) Filed: Apr. 21, 2003

(30) Foreign Application Priority Data
Apr. 22, 2002 (JP) 2002-119367

(51) Int. Cl. H04N 5/235

(52) U.S. Cl. 348/362

(57) ABSTRACT

An image pickup device includes an image pickup unit which captures the image of a subject in first and second different exposure times. The device further includes an image combining circuit which adds a first image signal captured in the first exposure time and a second image signal captured in the second exposure time to create a composite image signal corresponding to the subject. It also includes a control circuit which controls the first and second exposure times in accordance with the difference in brightness among areas in the subject which is determined from the first and second image signals.

### CROSS-REFERENCE TO THE RELATED APPLICATIONS

This application is based upon and claims the benefit of priority from the prior Japanese Patent Application No. 2002-119367, filed Apr. 22, 2002, the entire contents of which are incorporated herein by reference.

### BACKGROUND OF THE INVENTION

1. Field of the Invention

The present invention relates to an image pickup device and method which permits a subject having a wide range of brightness, i.e., having a large difference in brightness among its areas to be captured. More specifically, the present invention relates to a technique to extend the dynamic range of a television camera.

2. Description of the Related Art

Usually, cameras that use imaging devices, such as charge coupled devices (CCDs), capture subjects with the amount of light incident on them suppressed to within a certain range because of the relationship between the limit of the charge storage capacity and the characteristics of the imaging devices. During outdoor shooting, therefore, there arises the problem that a dynamic range cannot be obtained which covers the entire brightness range of a subject. To extend the dynamic range, a conventional method uses an electronic shutter function. Using this function, the image of a subject is captured at different shutter speeds (a high and a low shutter speed) and signal processing is then performed on the resultant video signals.

FIGS. 5A and 5B show the operating principles of a conventional camera with a wide dynamic range. FIG. 5A shows an output video signal from a CCD (shutter images). FIG. 5B shows an output video signal from the wide dynamic range camera (composite images). In the output video signal, low-speed shutter images appear in alternate fields A1, A2, . . . and high-speed shutter images appear in alternate fields B1, B2, . . . . The low- and high-speed shutter images refer to video signals obtained from the CCD with its charge storage time controlled by an electronic shutter which applies shutter pulses directly to the CCD. The low-speed shutter images are ones obtained at a shutter speed of, say, 1/60 sec. The high-speed shutter images are ones obtained at a shutter speed of, say, 1/2000 sec.

In capturing the image of a subject which has a large difference in brightness among its areas, the low-brightness areas in the subject are captured at a low shutter speed. At this point, the high-brightness areas will saturate. On the other hand, the high-brightness areas in the subject are captured at a high shutter speed. At this point, the low-brightness areas in the subject are so dark that they cannot be captured. More specifically, a low-speed shutter image in the A1 field and a high-speed shutter image (not shown) in the B0 filed are combined into a first composite image. After that, a low-speed shutter image in the A1 field and a high-speed shutter image in the B1 filed are combined into a second composite image. Subsequent to this, the same operation is repeated. In this manner, the conventional wide dynamic range camera allows light and dark areas in a subject to be captured in a single image.

With the wide dynamic range camera, the ratio of high and low shutter speeds and the ratio at which two images are combined are fixed. Incorporation of an auto iris lens that automatically adjusts the amount of incident light entering the wide dynamic range camera will not allow the dynamic range to be extended. The ratio of electronic shutter speeds corresponds to the extension rate of dynamic range. For example, assuming that the low shutter speed is fixed at 1/60 second and the high shutter speed is fixed at 1/2000 second, it follows that the wide dynamic range camera has an extension rate of about 32.

FIG. 6 shows an arrangement of the conventional wide dynamic range camera. Images captured by an imaging device 1, i.e., a low-speed shutter image and a high-speed shutter image, are digitized by an analog-to-digital (A/D) converter 2 and then stored alternately into frame memories 3a and 3b in digital processing circuitry 3. The digital signals read from the frame memories 3a and 3b are fed into a combining circuit 3c where they are combined and then output to the outside of the digital processing circuitry 3 via a processing circuit 3d. A controller 4 comprises a CPU 4a and an exposure control unit 4b. The CPU 4a performs operations using photometric data from the digital processing circuitry 3. The results of the operations are sent from the CPU 4a to the digital processing circuitry 3 and the exposure control unit 4b for internal control of the digital processing circuitry and control of the imaging device 1 (see, for example, Jpn. Pat. Appln. KOKAI Publication No. 2000-32303).

As described above, the conventional image pickup device has allowed a subject having a large difference in brightness among its areas to be captured by combining images obtained at different electronic shutter speeds. For this reason, this conventional technique is effective in capturing still images, but is not suitable for capturing moving subjects (moving images) as in the case of monitoring cameras.

### BRIEF SUMMARY OF THE INVENTION

According to an aspect of the present invention there is provided an image pickup device comprising: an image pickup unit which captures the image of a subject in first and second different exposure times; an image combining circuit which adds a first image signal captured in the first exposure time and a second image signal captured in the second exposure time to create a composite image signal corresponding to the subject; and a control circuit which controls the first and second different exposure times in accordance with the difference in brightness among areas in the subject which is determined from the first and second image signals.

According to another aspect of the present invention there is provided an image pickup method comprising: capturing the image of a subject in first and second different exposure times to produce a first image signal as a unit of the image based on the first exposure time and a second image signal as a unit of the image based on the second exposure time; adding the first image signal based on the first exposure time and the second image signal based on the second exposure time to create a composite image signal; dividing each of the first and second image signals into a plurality of areas and integrating brightness values in each of the areas; extracting n low-brightness areas in order of brightness level beginning with the lowest on the basis of comparison among the brightness value integration results in the areas obtained from the first image signal and calculating the brightness average in the n low-brightness areas; extracting m high-brightness areas in order of brightness level beginning with the highest on the basis of comparison among the brightness value integration results in the areas obtained from the second image signal and calculating the brightness average in the m high-brightness areas; and producing a first control signal to control the first exposure time on the basis of the calculation of the low-brightness average and a second control signal to control the second exposure time on the basis of the calculation of the high-brightness average.

### BRIEF DESCRIPTION OF THE SEVERAL VIEWS OF THE DRAWING

FIG. 1 is a block diagram of a wide dynamic range camera according to an embodiment of the present invention;

FIG. 2 is a diagram for use in explanation of the processing in the integrating circuit in the camera of FIG. 1;

FIG. 3 is a schematic diagram of the microcomputer circuit in the camera of FIG. 1;

FIGS. 4A and 4B are diagrams for use in explanation of the processing in the split image averaging section in the microcomputer circuit of FIG. 3;

FIGS. 5A and 5B are waveform diagrams for use in explanation of the operation and problems of a conventional wide dynamic range camera; and

FIG. 6 is a block diagram of the conventional wide dynamic range camera.

### DETAILED DESCRIPTION OF THE INVENTION

Hereinafter, an embodiment of the present invention will be described with reference to the accompanying drawings.

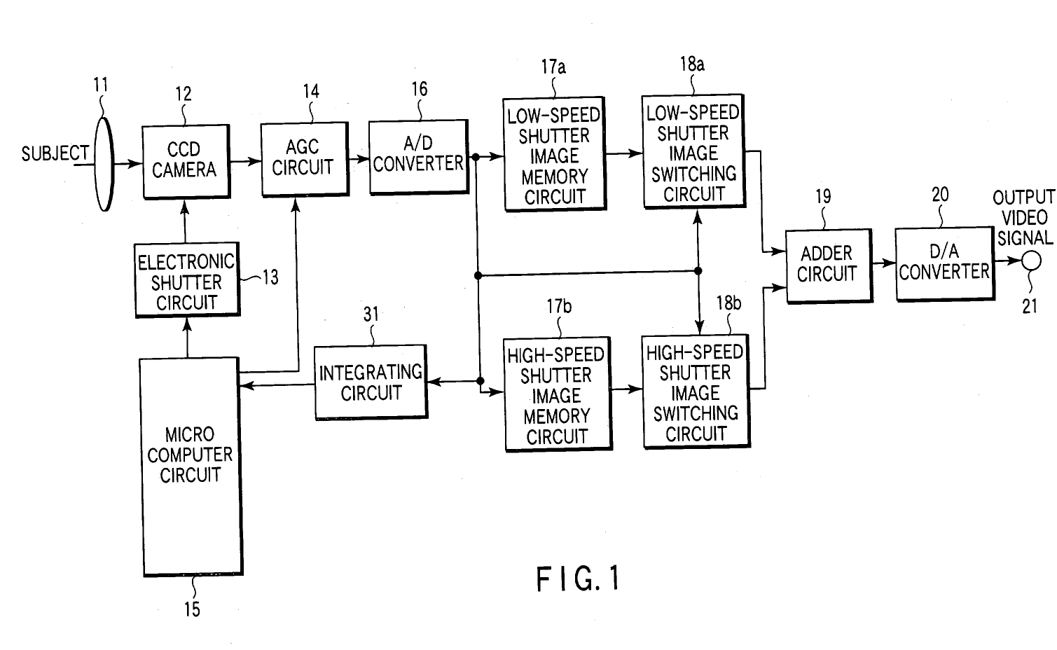

FIG. 1 is a block diagram of a wide dynamic range camera (television camera) according to an embodiment of the present invention. The image of a subject is formed through an imaging lens system 11 on the imaging device of a CCD camera (image pickup unit) 12 and converted into an electrical signal, or an analog video signal. The analog video signal from the CCD camera 12 is input to an AGC (Automatic Gain Control) circuit 14. The gain of the AGC circuit 14 is controlled by a microcomputer circuit 15 with each field. That is, the AGC circuit 14 is arranged such that its gain for an analog video signal obtained at a low shutter speed and its gain for an analog video signal obtained at a high shutter speed are controlled independently. The amplitude-controlled analog video signal output from the AGC circuit 14 is fed into an analog-to-digital (A/D) converter 16 where the input signal is converted into a digital video signal.

The imaging device of the CCD camera 12 is controlled by an electronic shutter circuit 13 to operate at two different electronic shutter speeds: a low shutter speed and a high shutter speed. That is, the electronic shutter circuit 13 provides the CCD camera 12 with electronic shutter signals (shutter pulses) each of which corresponds to a respective one of the low and high shutter speeds. Thereby, the shutter speed (exposure time) is allowed to vary with each field and a low-speed shutter image and a high-speed shutter image are alternately output from the CCD camera 12 with each field (so-called intermittent signals). The low-speed shutter image is an analog video signal at the low shutter speed as a first image signal constituting a unit of the image and taken in a first exposure time. The high-speed shutter image is an analog video signal at the high shutter speed as a second image signal constituting a unit of the image and taken in a second exposure time shorter than the first exposure time.

Of the digital video signals output from the A/D converter 16, the digital video signal at the low shutter speed is input to a low-speed shutter image memory circuit 17a, and the digital video signal at the high shutter speed is input to a high-speed shutter image memory circuit 17b. Each of the memory circuits 17a and 17b is a memory of a one vertical period type. The output of the A/D converter 16 is also applied to an integrating circuit (integration circuit) 31.

The input signal and the output signal of the low-speed shutter memory circuit 17a are input to a low-speed shutter image switching circuit 18a. The input signal and the output signal of the high-speed shutter image memory circuit 17b are input to a high-speed shutter image switching circuit 18b. The digital video signal at the low shutter speed and the digital video signal at the high shutter speed are both intermittent signals and converted into successive signals by the switching circuits 18a and 18b, respectively. That is, the digital video signals at the low shutter speed in alternate fields are output in succession from the low-speed shutter image switching circuit 18a as low-speed shutter video signals which appear in successive fields. The digital video signals at the high shutter speed in alternate fields are output in succession from the high-speed shutter image switching circuit 18b as high-speed shutter video signals which appear in successive fields. The output signals of the switching circuits 18a and 18b are applied to an adder 19 which is an image combining circuit. The adder 19 adds together the low-speed shutter video signal and the high-speed shutter video signal to yield a video signal (a composite video signal) having a wide range of brightness and then performs signal processing, such as nonlinear processing, on the composite video signal. The output of the adder 19 is applied to a digital-to-analog (D/A) converter 20 for conversion into an analog video signal. The analog video signal is output through an output terminal 21 to the outside of the control circuitry.

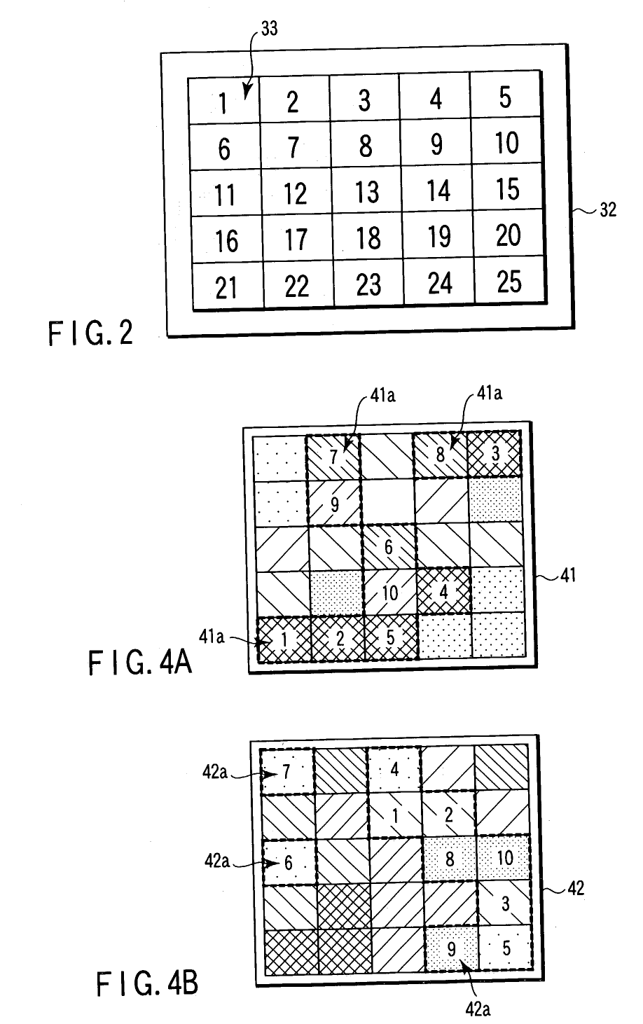

In the integrating circuit 31, the digital video signal from the A/D converter 16 is used to calculate image information for determining the shutter speed (shutter pulse duration) of the electronic shutter circuit 13. That is, the integrating circuit 31 splits a digital video signal 32 at each of the low and high shutter speeds into 25 areas 33 as shown in FIG. 2, then integrates brightness signal values in each area 33 and outputs a brightness integrated value obtained for each area 33 as image information. The outputs of the integrating circuit 31 are sent to the microcomputer 15 where they are used to determine the shutter speed of the electronic shutter circuit 13. That is, the microcomputer determines an electronic shutter signal for the high-speed shutter on the basis of brightness integrated values (high-speed image integrated values) obtained from a digital video signal at the high shutter speed by the integrating circuit 31.

Likewise, an electronic shutter signal for the low-speed shutter is determined on the basis of brightness integrated values (low-speed image integrated values) obtained from a digital video signal at the low shutter speed by the integrating circuit 31. Thus, the electronic shutter circuit 13 is automatically controlled in accordance with the shutter speeds determined by the microcomputer 15.

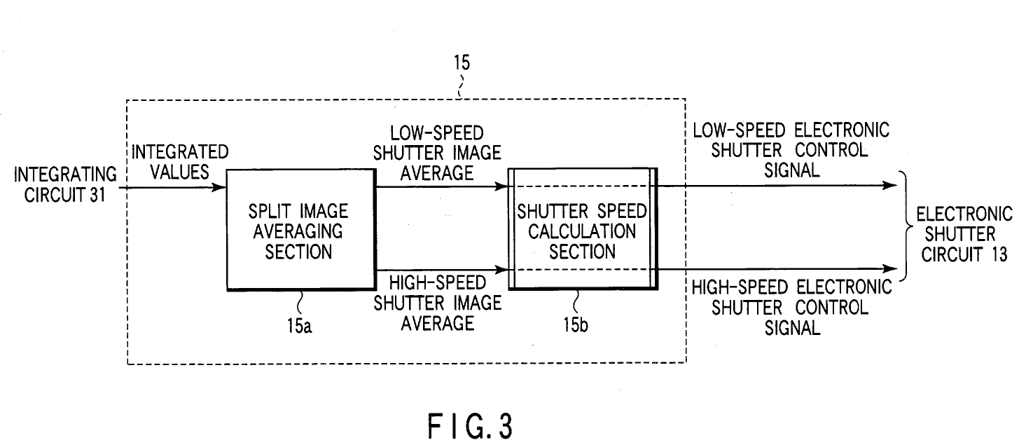

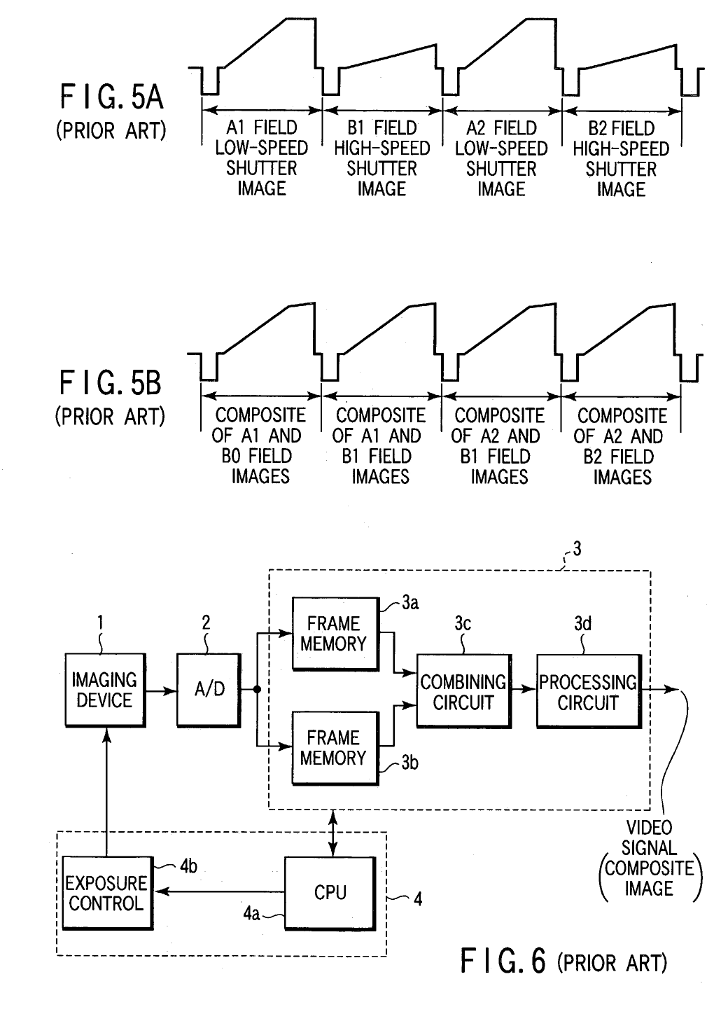

The configuration (software blocks) of the microcomputer 15 for automatically controlling the electronic shutter circuit 13 will be described below. Here, only the internal blocks associated with the automatic control of the electronic shutter circuit 13 are illustrated. As shown in FIG. 3, the microcomputer 15 has a split image averaging section (brightness average calculation section) 15a and a shutter speed calculation section (exposure time control signal producing section) 15b. The split image averaging section 15a determines the low-speed image brightness average associated with low-brightness areas of a subject from the low-speed image integrated values from the integrating circuit 31 and the high-speed image brightness average associated with high-brightness areas of that subject from the high-speed image integrated values from the integrating circuit 31. The resultant averages are output to the shutter speed calculation section 15b.

The details of processing in the split image averaging section 15a will be described later. Based on the low-speed image brightness average and the high-speed image brightness average from the split image averaging section 15a, the shutter speed calculation section 15b calculates a low-speed electronic shutter control signal (a first control signal) and a high-speed electronic shutter control signal (a second control signal) and outputs them to the electronic shutter circuit 13. Thus, the low and high shutter speeds are calculated from the brightness values. Thereby, the optimum electronic shutter speeds can be obtained for the low- and high-brightness areas of the subject.

Reference is now made to FIGS. 4A and 4B to describe briefly the processing by the split image averaging section 15a. FIG. 4A schematically illustrates low-speed image integrated values 41 obtained from the digital video signal 32 captured at low shutter speed. The split image averaging section 15a extracts from the low-speed integrated values 41 some low-brightness areas 41a in order of brightness, beginning with the lowest. Further, the averaging section 15a adds brightness values of n low-brightness areas 41a until the area of all the areas extracted amounts to a fixed value and seeks their average. In this example, the digital video signal at low shutter speed is split into 25 areas 41a (corresponding to the areas 33 in FIG. 2). The brightness values of areas from the least bright area labeled 1 to the tenth least bright area labeled 10 are added and averaged. In this manner, the brightness average of low-brightness areas of a subject is calculated as the low-speed image average (average of all pixels) and then output to the shutter speed calculation section 15b.

FIG. 4B schematically illustrates high-speed image integrated values 42 obtained from the digital video signal 32 captured at high shutter speed. The split image averaging section 15a extracts from the high-speed image integrated values 42 some high-brightness areas 42a in order of brightness, beginning with the highest. Further, the averaging section 15a adds brightness values of m high-brightness areas 42a until the area of all the areas extracted amounts to a fixed value and seeks their average. In this example, the digital video signal at high shutter speed is split into 25 areas 42a (corresponding to the areas 33 in FIG. 2). The brightness values of areas from the brightest area labeled 1 to the tenth brightest area labeled 10 are added and averaged. In this manner, the brightness average of high-brightness areas of the subject is calculated as the high-speed image average (average of all pixels) and then output to the shutter speed calculation section 15b.

Using each of the low- and high-speed image brightness average values thus calculated separately, the shutter speed calculation section 15b produces a low-speed electronic shutter control signal for the low shutter speed most suitable for capturing the low-brightness areas of the subject and a high-speed electronic shutter control signal for the high shutter speed most suitable for capturing the high-brightness areas of the subject. It therefore becomes possible to vary the dynamic range of the television camera at high speed in accordance with the magnitude of a difference in brightness among areas of a subject.

In calculating the average of brightness levels of all pixels, the n low-brightness areas 41a and the m high-brightness areas 42a are extracted in accordance with the percentages of the areas of low- and high-brightness portions in a subject in the digital video signals 32 captured at low- and high-shutter speeds. This allows the low-brightness areas 41a and the high-brightness areas 42a to take up large areas for all pixel averaging. For this reason, it becomes possible to extend the dynamic range linearly without loss of intermediate brightness in comparison with a technique to separate the low-brightness areas 41a and the high-brightness areas 42a on the basis of brightness levels (for example, U.S. patent application Ser. No. 10/115,973).

As described above, this embodiment allows the camera dynamic range to be changed at high speed according to the magnitude of a difference in brightness among areas in a subject. That is, an exposure time (low shutter speed) most suitable for capturing low-brightness portions of a subject and an exposure time (high shutter speed) most suitable for capturing high-brightness portions of that subject can be calculated on the basis of video signals captured at different electronic shutter speeds. This allows a subject having a very wide range of brightness to be captured successfully.

Furthermore, by making the areas in a subject for all pixel averaging large in area, the relationship in brightness level between a digital video signal at low shutter speed and a digital video signal at high shutter speed can be made natural. For this reason, the above-described embodiments is well suited for use in image pickup devices for dynamically changing subjects, in particular, onboard cameras for image recognition and monitoring cameras which capture outdoor scenes at night and indoor scenes, in a situation where subjects have a very wide range of brightness.

Thus, the electronic shutter speeds can be determined at all times according to the brightness of a subject. The nonlinear processing of the resulting composite image allows dark and light portions in the subject to be captured successfully.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image pickup device comprising:
an image pickup unit which captures the image of a subject in first and second different exposure times;
an image combining circuit which adds a first image signal captured in the first exposure time and a second image signal captured in the second exposure time to create a composite image signal corresponding to the subject; and
a control circuit which controls the first and second different exposure times in accordance with the difference in brightness among areas in the subject which is determined from the first and second image signals.

2. An image pickup device according to claim 1, wherein the first exposure time is longer than the second exposure time.

3. An image pickup device according to claim 1, wherein the image pickup unit includes an electronic shutter.

4. An image pickup device according to claim 1, wherein the control circuit includes an integration circuit which divides each of the first and second image signals into a plurality of areas and integrates brightness values in each of the areas.

5. An image pickup device according to claim 4, wherein the control circuit includes a low-brightness average calculation circuit which extracts n low-brightness areas in order of brightness level beginning with the lowest on the basis of comparison among the brightness value integration results of the areas obtained from the first image signal and calculates the brightness average in the n low-brightness areas, and a high-brightness average calculation circuit which extracts m high-brightness areas in order of brightness level beginning with the highest on the basis of comparison among the brightness value integration results of the areas obtained from the second image signal and calculates the brightness average in the m high-brightness areas.

6. An image pickup device according to claim 5, wherein the control circuit further includes an exposure time control signal producing circuit which produces first and second control signals that control the first and second exposure times, respectively, on the basis of the resultant brightness averages.

7. An image pickup device comprising:
an image pickup unit which captures the image of a subject in first and second different exposure times to produce a first image signal as a unit of the image based on the first exposure time and a second image signal as a unit of the image based on the second exposure time;
an image combining circuit which adds the first image signal based on the first exposure time and the second image signal based on the second exposure time to create a composite image signal;
an integration circuit which divides each of the first and second image signals into a plurality of areas and integrates brightness values in each of the areas;
a low-brightness average calculation section which extracts n low-brightness areas in order of brightness level beginning with the lowest on the basis of comparison among the brightness value integration results in the areas obtained from the first image signal and calculates the brightness average in the n low-brightness areas;
a high-brightness average calculation section which extracts m high-brightness areas in order of brightness level beginning with the highest on the basis of comparison among the brightness value integration results in the areas obtained from the second image signal and calculates the brightness average in the m high-brightness areas; and
an exposure time control signal producing section which produces a first control signal to control the first exposure time on the basis of the calculation of the brightness average by the low-brightness average calculation section and a second control signal to control the second exposure time on the basis of the calculation of the brightness average by the high-brightness average calculation section.

8. An image pickup device according to claim 7, further comprising a shutter circuit which controls the first and second exposure times according to the first and second control signals, respectively.

9. An image pickup device according to claim 7, wherein the first exposure time is longer than the second exposure time.

10. An image pickup device according to claim 7, wherein the image pickup unit includes an electronic shutter.

11. An image pickup method comprising:
capturing the image of a subject in first and second different exposure times to produce a first image signal as a unit of the image based on the first exposure time and a second image signal as a unit of the image based on the second exposure time;
adding the first image signal based on the first exposure time and the second image signal based on the second exposure time to create a composite image signal;
dividing each of the first and second image signals into a plurality of areas and integrating brightness values in each of the areas;
extracting n low-brightness areas in order of brightness level beginning with the lowest on the basis of comparison among the brightness value integration results in the areas obtained from the first image signal and calculating the brightness average in the n low-brightness areas;
extracting m high-brightness areas in order of brightness level beginning with the highest on the basis of comparison among the brightness value integration results in the areas obtained from the second image signal and calculating the brightness average in the m high-brightness areas; and
producing a first control signal to control the first exposure time on the basis of the calculation of the low-brightness average and a second control signal to control the second exposure time on the basis of the calculation of the high-brightness average.

12. An image pickup method according to claim 11, wherein the first exposure time is longer than the second exposure time.
